(19) United States
(12) Patent Application Publication
(10) Pub. No.: US 2025/0377274 A1
(43) Pub. Date: Dec. 11, 2025

(54) Isochoric In Situ Mechanical Testing of Materials

(71) Applicant: Alpine Polytech, LP, Fort Worth, TX (US)

(72) Inventor: J. Buc Slay, Fort Worth, TX (US)

(73) Assignee: Alpine Polytech, LP, Fort Worth, TX (US)

(21) Appl. No.: 19/222,080

(22) Filed: May 29, 2025

Related U.S. Application Data
(60) Provisional application No. 63/657,279, filed on Jun. 7, 2024.

(51) Int. Cl. G01N 3/02; G01N 3/08

(52) U.S. Cl. CPC G01N 3/02; G01N 3/08

(57) ABSTRACT

An in situ chamber assembly for mechanical testing of materials. The in situ chamber assembly includes a pressure vessel having first and second end caps. A pull rod extends through the pressure vessel and has a sliding and sealing relationship with the first and second end caps. A specimen retainer assembly is disposed within the pressure vessel. The specimen retainer assembly including a fixed portion coupled to the pressure vessel and a movable portion coupled to the pull rod. At least one specimen is positioned between the fixed portion and the movable portion of the specimen retainer assembly such that movement of the pull rod relative to the pressure vessel applies a load on the at least one specimen. In operation, movement of the pull rod relative to the pressure vessel occurs isochorically and isobarically.

### CROSS-REFERENCE TO RELATED APPLICATIONS

The present application claims the benefit of U.S. Provisional Application No. 63/657,279, filed Jun. 7, 2024 the entire contents of which are hereby incorporated by reference.

### TECHNICAL FIELD OF THE DISCLOSURE

The present disclosure relates, in general, to material testing for characterizing the mechanical properties of a material and, in particular, to isochoric mechanical testing of material specimens positioned within an in situ chamber assembly such that load measurements are independent of the pressure in the chamber.

### BACKGROUND

Destructive testing of material specimens, under either ambient conditions or in situ conditions, is a valuable technique for understanding the mechanical properties and behaviors of a material. For example, by subjecting a material specimen to controlled tension until failure, researchers can gather valuable data on parameters such as tensile strength, elongation and modulus of elasticity. In such tensile tests, the material specimen is gripped securely at both ends and pulled apart at a constant rate using, for example, a universal testing machine. The applied force and resulting deformation are continuously monitored and recorded throughout the tensile test. This data is then used to calculate various mechanical properties and generate stress-strain curves that provide insights into the behavior of the material under tension. Conducting material testing under selected pressure, temperature and/or fluid exposure conditions in a chamber, allows researchers to study the effects of these conditions on the mechanical properties of the material. By simulating extreme conditions, such as those found in oil and gas exploration, deep-sea operations and aerospace applications, researchers can gain a better understanding of how a material performs and potentially fails in such environments. This in situ testing knowledge is critical for designing and developing materials that can withstand severe conditions without compromising their performance. Destructive testing of material specimens, both under ambient and in situ conditions, is an essential tool for characterizing the mechanical properties of materials with the testing data informing material selection and serving as a guide for the development of new materials and components with improved performance characteristics tailored for specific applications.

### SUMMARY

In a first aspect, the present disclosure is directed to an in situ chamber assembly for mechanical testing of materials. The in situ chamber assembly includes a pressure vessel having first and second end caps. A pull rod extends through the pressure vessel and has a sliding and sealing relationship with the first and second end caps. A specimen retainer assembly is disposed within the pressure vessel. The specimen retainer assembly including a fixed portion coupled to the pressure vessel and a movable portion coupled to the pull rod. At least one specimen is positioned between the fixed portion and the movable portion of the specimen retainer assembly such that movement of the pull rod relative to the pressure vessel applies a load on the at least one specimen. Movement of the pull rod relative to the pressure vessel occurs isochorically.

In some embodiments, a fluid may be sealed within the pressure vessel with the at least one specimen exposed to the fluid. In certain embodiments, the fluid may be in a gaseous state or in a liquid state. In some embodiments, the fluid may be a multiphase fluid. In certain embodiments, the fluid may have a temperature that is less than or greater than ambient temperature. In some embodiments, the fluid may have a pressure that is less than or greater than ambient pressure. In certain embodiments, the at least one specimen may be a plurality of specimens positioned between the fixed portion and the movable portion of the specimen retainer assembly. In such embodiments, the plurality of specimens may include first and second specimens positioned on opposite sides of the pull rod.

In some embodiments, the plurality of specimens may include first, second and third specimens positioned radially outwardly relative to the pull rod and circumferentially distributed about the pull rod. In certain embodiments, the specimens may be positioned radially outwardly relative to the pull rod and uniformly circumferentially distributed about the pull rod. In some embodiments, a tubular may be coupled to the first end cap to the exterior of the pressure vessel such that the pull rod extends into the tubular. In such embodiments, the tubular may limit movement of the pull rod relative to the pressure vessel. In certain embodiments, the material of the at least one specimen may be selected from the group consisting of elastomers, polymers, thermoplastics, thermosets, foams, fibers, fabrics, composites, ceramics and metals. In some embodiments, the load applied to the at least one specimen responsive to movement of the pull rod relative to the pressure vessel may be selected from the group consisting of tensile loads, compression loads, bending loads and shear loads. In certain embodiments, a thermal jacket may be positioned around an exterior of the pressure vessel.

In a second aspect, the present disclosure is directed to an in situ chamber assembly for mechanical testing of materials. The in situ chamber assembly includes a pressure vessel having first and second end caps. A pull rod extends through the pressure vessel and has a sliding and sealing relationship with the first and second end caps. A specimen retainer assembly is disposed within the pressure vessel. The specimen retainer assembly including a fixed portion coupled to the pressure vessel and a movable portion coupled to the pull rod. At least one specimen is positioned between the fixed portion and the movable portion of the specimen retainer assembly. A pressurized fluid is sealed within the pressure vessel with the at least one specimen being exposed to the pressurized fluid. Movement of the pull rod relative to the pressure vessel is configured to apply a load on the at least one specimen. Movement of the pull rod relative to the pressure vessel occurs isochorically and isobarically.

In a third aspect, the present disclosure is directed to a testing apparatus for mechanical testing of materials. The testing apparatus includes a testing machine and an in situ chamber assembly that is coupled to the testing machine. The in situ chamber assembly includes a pressure vessel having first and second end caps. A pull rod extends through the pressure vessel and has a sliding and sealing relationship with the first and second end caps. A specimen retainer assembly is disposed within the pressure vessel. The specimen retainer assembly including a fixed portion coupled to the pressure vessel and a movable portion coupled to the pull rod. At least one specimen is positioned between the fixed portion and the movable portion of the specimen retainer assembly such that movement of the pull rod relative to the pressure vessel applies a load on the at least one specimen. Movement of the pull rod relative to the pressure vessel occurs isochorically.

In some embodiments, the testing machine may include a loading frame having a base, a crosshead and a load cell coupled to the crosshead. In such embodiments, the pull rod may have first and second ends with the first end of the pull rod coupled to the crosshead. Also, in such embodiments, the in situ chamber assembly may include a tubular having first and second ends with the first end of the tubular coupled to the first end cap and configured to receive the second end of the pull rod. The second end of the tubular may be coupled to the base of the loading frame such that the tubular limits movement of the pull rod relative to the pressure vessel. In operation, load measurements taken by the load cell are independent of the pressure within the pressure vessel.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIG. 1 is a schematic illustration of an exemplary testing apparatus including an in situ chamber assembly for mechanical testing of materials in accordance with embodiments of the present disclosure;

FIGS. 2A-2B are prior art drawings depicting a conventional material testing chamber;

FIGS. 3A-3D are isometric views partially cut away and cross sectional views of an in situ chamber assembly for mechanical testing of materials in accordance with embodiments of the present disclosure;

FIGS. 4A-4B are isometric views partially cut away of an in situ chamber assembly for mechanical testing of materials performing a tensile test in accordance with embodiments of the present disclosure;

FIG. 5 is a representative tensile stress versus nominal strain graph for the tensile test performed by the in situ chamber assembly in FIG. 4;

FIG. 6 is an isometric view partially cut away of an in situ chamber assembly for mechanical testing of materials performing a tensile test in accordance with embodiments of the present disclosure;

FIG. 7 is an isometric view partially cut away of an in situ chamber assembly for mechanical testing of materials performing a compression test in accordance with embodiments of the present disclosure;

FIG. 8 is an isometric view partially cut away of an in situ chamber assembly for mechanical testing of materials performing a bending test in accordance with embodiments of the present disclosure;

FIG. 9 is an isometric view partially cut away of an in situ chamber assembly for mechanical testing of materials performing a shear test in accordance with embodiments of the present disclosure;

FIG. 10 is an isometric view partially cut away of an in situ chamber assembly for mechanical testing of materials performing a tensile test in accordance with embodiments of the present disclosure; and

FIG. 11 is an isometric view partially cut away of an in situ chamber assembly for mechanical testing of materials performing a tensile test in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

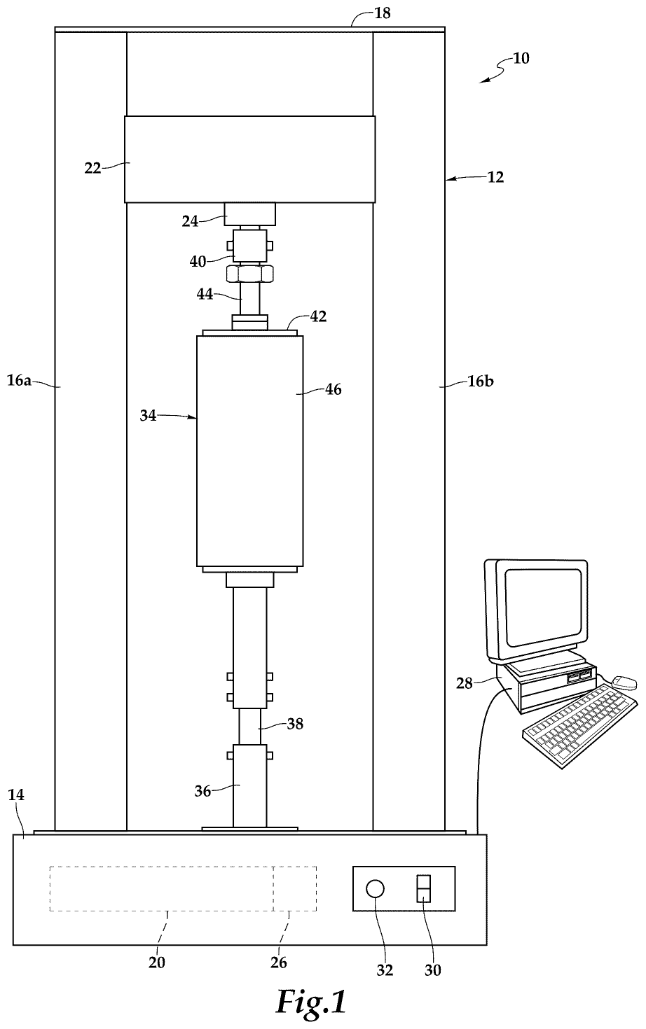

Referring to FIG. 1 in the drawings, a testing machine capable of control and measurement of displacement and force that is depicted as a universal testing machine is schematically illustrated and generally designated 10. Testing machine 10 includes electromechanical and/or hydraulic systems used for performing mechanical testing of material specimens such as tensile testing, compression testing, bending testing and shear testing, to name a few. The data obtained from testing machine 10 is used to calculate various mechanical properties, generate stress-strain curves and evaluate the behavior of the materials under loads. Testing machine 10 includes a loading frame 12 that provides structural supports for the testing system. Loading frame 12 includes a base 14, columns 16a, 16b and an upper cross member 18. In the illustrated embodiment, base 14 houses a control system and drive mechanism 20 that is used to raise and lower a crosshead 22 at a desired rate, set test parameters and perform data acquisition using a plurality of transducers including, for example, a load cell 24 that measures the applied force or load and an extensometer 26 that measures the elongation or deformation. Testing machine 10 includes a computing system 28 that is in communication with loading frame 12. Computing system 28 operates data acquisition and analysis software that compiles and processes the test data collected during testing operations and outputs information relating to the test specimens such as load-displacement curves, stress-strain curves and mechanical property information including tensile strength, elongation and modulus of elasticity.

In the illustrated embodiment, base 14 includes a control panel depicted as including a crosshead rocker switch 30 for raising and lowering crosshead 22 manually and an emergency stop button 32. An in situ chamber assembly 34 is positioned within loading frame 12. At its lower end, in situ chamber assembly 34 is coupled to a tubular receiver 36 of base 14 using an adaptor 38 that may be secured on opposite side to in situ chamber assembly 34 and tubular receiver 36 using pins, bolts, threads or other suitable connecting means. Likewise, at its upper end, in situ chamber assembly 34 is coupled to crosshead 22 via load cell 24 using an adaptor 40 that may be secured on opposite side to in situ chamber assembly 34 and load cell 24 using pins, bolts, threads or other suitable connecting means. In the illustrated embodiment, in situ chamber assembly 34 includes a pressure vessel 42 that contains a fluid therein at a desired pressure, a pull rod 44 that extends through pressure vessel 42 and a temperature control device depicted as a thermal jacket 46 that is configured to control the temperature of the fluid within pressure vessel 42. Once in situ chamber assembly 34 is coupled to loading frame 12, testing machine 10 may be used to subject material specimens disposed within in situ chamber assembly 34 to mechanical loads by moving crosshead 22 up or down relative to base 14 in a controlled manner.

The material testing may be performed under ambient conditions, the prevailing environmental conditions, such as the temperature, pressure and atmosphere that surrounds testing machine 10. Alternatively, using in situ chamber assembly 34, the material testing may be performed in an environment designed to simulate a physical environment (e.g., temperature and pressure) and/or a chemical environment (e.g., fluid) in which the material may be used. By simulating extreme conditions, such as those encountered in oil and gas exploration, deep-sea operations and aerospace applications, testing material specimens using in situ chamber assembly 34 enables a better understanding of how a material or component performs and potentially fails in such environments, which is critical for designing and developing materials and components that can withstand severe conditions without compromising their performance.

By way of example and not limitation, in situ chamber assembly 34 allows material specimens to be tested in pressures below ambient pressure, such at down to a vacuum, and in pressures above ambient pressure, such as pressures between atmospheric pressure and one hundred pound per square inch (psi), pressures between one hundred psi and one thousand psi, pressures between one thousand psi and ten thousand psi, pressures between ten thousand psi and one hundred thousand psi or other desired pressure. Likewise, by way of example and not limitation, in situ chamber assembly 34 allows material specimens to be tested at temperatures below ambient temperature, such temperatures between 0 degrees Celsius and negative 150 degrees Celsius as well as cryogenic temperatures between negative 150 degrees Celsius and negative 270 degrees Celsius, and temperatures above ambient temperature, such as temperatures between twenty-five degrees Celsius and one hundred degrees Celsius, temperatures between one hundred degrees Celsius and five hundred degrees Celsius, temperatures between five hundred degrees Celsius and one thousand degrees Celsius or other desired temperature.

In addition, by way of example and not limitation, in situ chamber assembly 34 allows material specimens to be tested in an environment containing a fluid other than air such as a pure gas environment of oxygen, nitrogen, carbon dioxide, hydrogen, helium, hydrogen sulfide, methane or other hydrocarbon gas, ammonia or other desired pure gas or mixture of gases. Likewise, by way of example and not limitation, in situ chamber assembly 34 allows material specimens to be tested in fluid environments containing fluids other than gases such as liquids including acids, bases, synthetics, oils, seawater or other desired liquid or mixture of liquids. Also, by way of example and not limitation, in situ chamber assembly 34 allows material specimens to be tested in a fluid environment containing a multiphase fluid including a combination of liquids and gases such as a multiphase hydrocarbon fluid. Further, by way of example and not limitation, in situ chamber assembly 34 allows material specimens to be tested in chemical environments that change states at different pressure and temperature combinations including state changes between solids, liquids, gases and/or supercritical phases such as a state changing carbon dioxide environment.

As discussed herein, operation of crosshead 22 causes movement of pull rod 44 relative to pressure vessel 42 in order to place a load on one or more material specimens positioned within pressure vessel 42. Importantly, the movement of pull rod 44 relative to pressure vessel 42 is a constant-volume process that occurs without changing the available fluid volume within pressure vessel 42 such that the process will be referred to herein as occurring isovolumetrically or isochorically. In addition, during the movement of pull rod 44 relative to pressure vessel 42, thermal jacket 46 may be configured to maintain the fluid within pressure vessel 42 at a constant temperature such that the process will be referred to herein as occurring isothermally. Further, during the movement of pull rod 44 relative to pressure vessel 42, due to the isochoric and isothermal nature of the process, the pressure within pressure vessel 42 remains constant such that the process will be referred to herein as occurring isobarically. Even though testing machine 10 is depicted as a universal testing machine, it should be understood by those having ordinary skill in the art that the in situ chamber assembly of the present disclosure is equally well-suited for use with other testing machines that provide control and measurement of displacement and force including, but not limited to, dead weight testing machines, creep load testing machines, lever arm testing machines, high strain rate testing machines and cyclic testing machines.

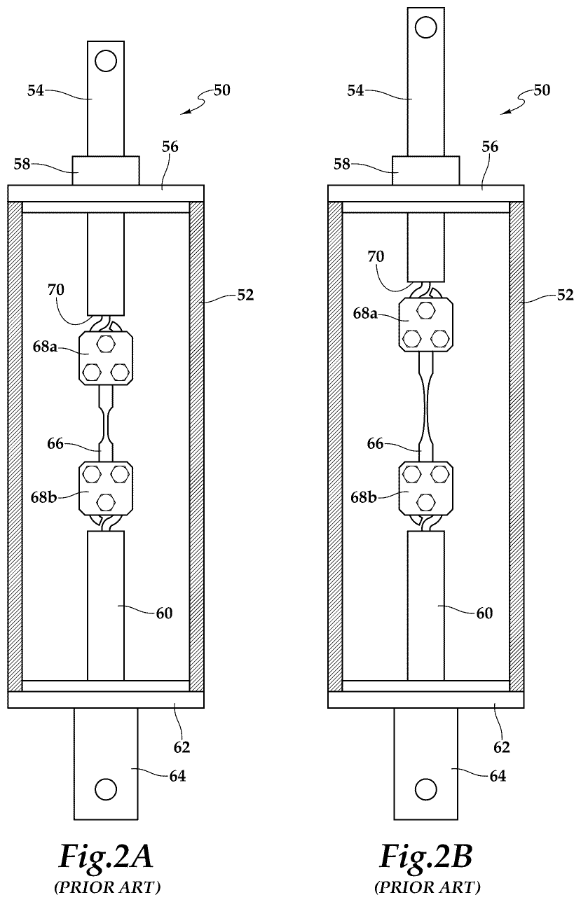

Unlike in situ chamber assembly 34 of the present disclosure, conventional material testing chambers are unable to perform mechanical testing of materials isochorically. As best seen in FIG. 2A-2B of the drawings, a conventional material testing chamber assembly 50 is depicted in a partial cut away format to show the interior thereof. Chamber assembly 50 includes a pressure vessel 52, a moveable pull rod 54 that extends outwardly from pressure vessel 52 through an upper end cap 56 and a seal assembly 58, and a fixed pull rod 60 coupled to a lower end cap 62. Chamber assembly 50 is positioned within a testing machine, such as a universal testing machine, by coupling a lower end cap tubular 64 to the tubular receiver of the base of the loading frame and by coupling moveable pull rod 54 to the crosshead via the load cell. As illustrated, a material specimen 66 is positioned between moveable pull rod 54 and fixed pull rod 60 and is held in place by an upper grip 68a and a lower grip 68b. Pressure vessel 52 is designed to contain a pressurized fluid such as a gas or a liquid therein and a temperature control device (not shown) controls the temperature of the fluid therein. During testing, the load cell of the testing machine measures the load to deflect the specimen, the load created by friction between moveable pull rod 54 and seal assembly 58, and the piston force created by the internal pressure acting on the lower surface area 70 of moveable pull rod 54. Commonly, the load created by the internal pressure is high relative to the load signal from specimen deflection and friction. For example, if pressure vessel 52 has an internal pressure of 10,000 psi and moveable pull rod 54 has lower surface area 70 of one square inch, the piston force acting on moveable pull rod 54 is 10,000 pounds while, at the same time, the force required to run the deflection test may be on the order of hundreds of pounds and the force associated with the friction force may be on the order of tens of pounds.

In addition, it has been found that movement of moveable pull rod 54 relative to pressure vessel 52 during material testing changes the available fluid volume within pressure vessel 52. This is evident in a comparison of the available fluid volume in FIG. 2A, prior to a tensile test, and the available fluid volume in FIG. 2B, during a tensile test, after a portion of moveable pull rod 54 has been retracted from pressure vessel 52, thereby creating additional available fluid volume in pressure vessel 52. This change in the available fluid volume within pressure vessel 52 as moveable pull rod 54 is retracted from pressure vessel 52, causes the pressure within pressure vessel 52 to decrease. This decrease in pressure occurs regardless of the fluid environment within pressure vessel 52 including in gases, more drastically with dense supercritical fluids and most pronounced with liquids. Even relatively small movements of moveable pull rod 54 relative to pressure vessel 52 during material testing that cause relatively small changes in the available fluid volume can have outsized impacts on internal pressure. As with the piston force created by the internal pressure, the change in the piston force created by the change in internal pressure can be high relative to the load signal from specimen deflection and friction. Thus, both the internal pressure and the change in internal pressure caused by the change in available fluid volume tend to mask the load signal from specimen deflection, which forms a critical part of the desired testing data. While attempts have been made to use secondary compensation devices that react to the movement of the moveable pull rod to offset the impact the change in available fluid volume has on the internal pressure, it has been found that these systems are complicated to manufacture, difficult to calibrate and problematic to use.

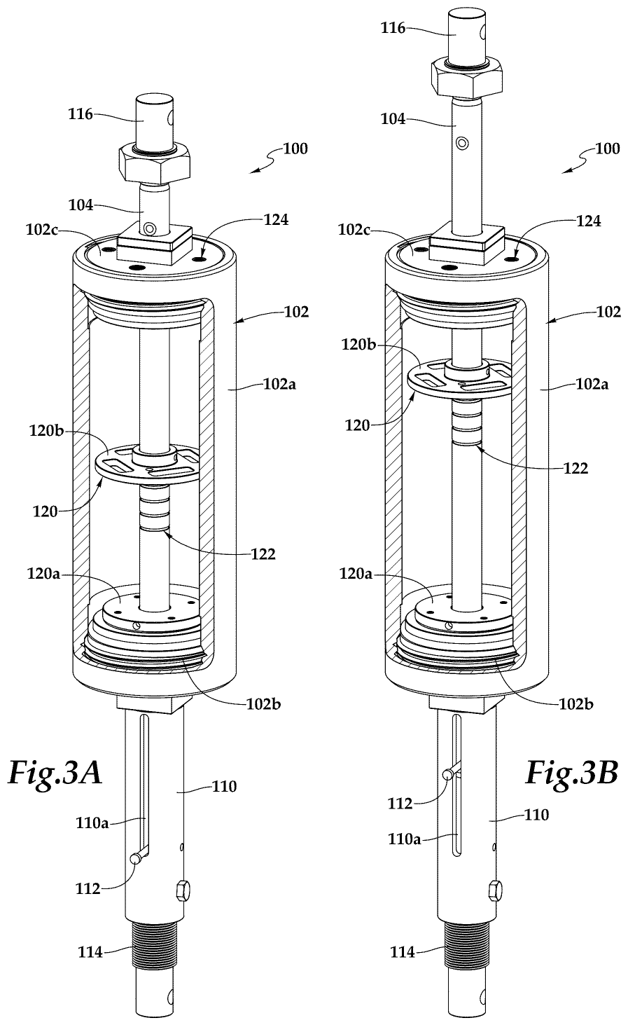

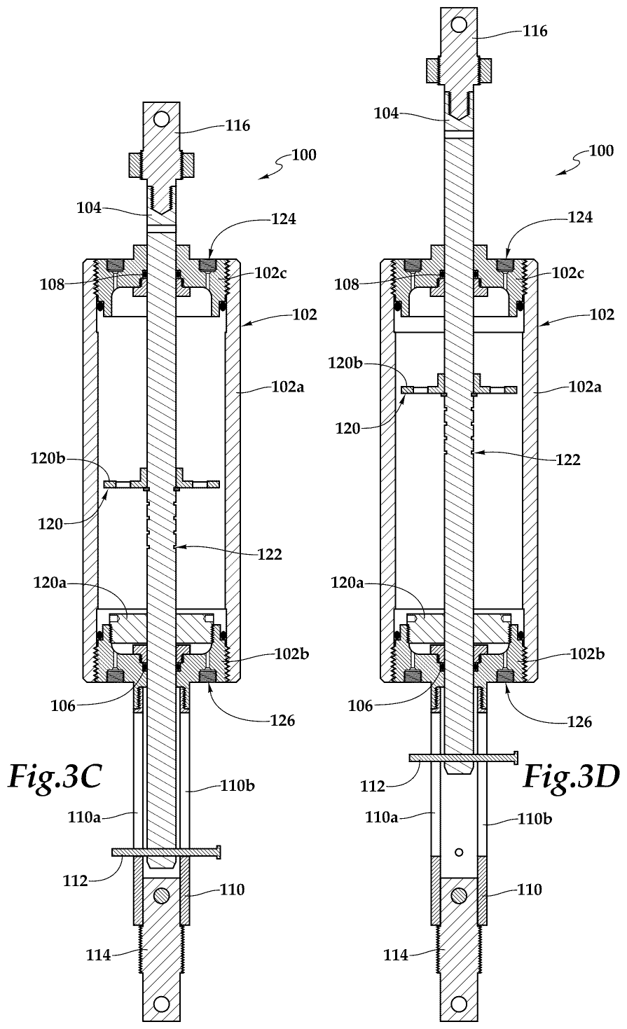

Referring next to FIGS. 3A-3D of the drawings, an in situ chamber assembly 100 that is representative of in situ chamber assembly 34 will now be discussed. In situ chamber assembly 100 includes a pressure vessel 102 that is depicted in a partial cut away format to show the interior thereof in FIGS. 3A-3B. In the illustrated embodiment, pressure vessel 102 has a generally cylindrical body 102a that may be formed from metal, composite, a composite overwrap or other suitable material. In other embodiments, the body of a pressure vessel of the present disclosure could have other configurations including a rectangular prism, a hexagonal prism, an octagonal prism or other suitable configuration. Body 102a may include one or more transparent windows formed from sapphire, quartz or other suitable material to enable viewing of the specimens and the use of monitoring equipment such as video or laser to record changes in the appearance, dimensions, displacements or other properties of the specimens as well as other aspects of the testing process. Pressure vessel 102 includes a lower end cap 102b that is threadably coupled to body 102a and an upper end cap 102c that is threadably coupled to body 102a. Each of lower end cap 102b and upper end cap 102c has a pull rod receiving opening in a central portion thereof, as best seen in FIGS. 3C-3D. A pull rod 104 extends through pressure vessel 102 and more particularly, through the pull rod receiving openings of lower end cap 102b and upper end cap 102c. Pull rod 104 has a sliding and sealing relationship with lower end cap 102b that is provided by a dynamic seal 106. Likewise, pull rod 104 has a sliding and sealing relationship with upper end cap 102c that is provided by a dynamic seal 108. A tubular 110 is threadably coupled to lower end cap 102b. Tubular 110 has a pair of oppositely disposed slots 110a, 110b. The upper end of tubular 110 receives the lower end pull rod 104 therein. A pin 112 extends through slots 110a, 110b and an opening in the lower end of pull rod 104 such that slots 110a, 110b define the range of movement of pull rod 104 relative to tubular 110 and thus relative to pressure vessel 102. The lower end of tubular 110 receives an upper end of an adaptor 114 therein. In the illustrated embodiment, tubular 110 and adaptor 114 are coupled together with a pin that extends through cooperating openings in tubular 110 and adaptor 114. Adaptor 114 enables in situ chamber assembly 100 to be coupled to, for example, a tubular receiver of a universal testing machine, as discussed herein. The upper end of pull rod 104 is threadably coupled to a lower end of an adaptor 116. Adaptor 116 enables in situ chamber assembly 100 to be coupled to, for example, a crosshead of a universal testing machine via a load cell, as discussed herein.

A specimen retainer assembly 120 is disposed within pressure vessel 102. Specimen retainer assembly 120 including a fixed portion 120a that is coupled to lower end cap 102b and a movable portion 120b that is coupled to pull rod 104. Pull rod 104 includes a plurality of grooves that are generally designated 122 that provide a plurality of locations for positioning movable portion 120b of specimen retainer assembly 120 such that the distance between movable portion 120b and fixed portion 120a can be selected based upon the testing to be performed. Responsive to the movement of the crosshead of the universal testing machine, for example, pull rod 104 is movable relative to pressure vessel 102 between a plurality of positions including a fully retracted position with pin 112 in contact with the bottom of slots 110a, 110b (see FIGS. 3A and 3C), a fully extended position with pin 112 in contact with the top of slots 110a, 110b and an infinite number of positions therebetween. When pull rod 104 moves upward relative to pressure vessel 102, the distance between movable portion 120b and fixed portion 120a of specimen retainer assembly 120 increases as seen in the comparison of FIG. 3A to FIG. 3B. When pull rod 104 moves downward relative to pressure vessel 102, the distance between movable portion 120b and fixed portion 120a of specimen retainer assembly 120 decreases as seen in the comparison of FIG. 3B to FIG. 3A.

Importantly, as pull rod 104 extends through pressure vessel 102, pull rod 104 does not have a lower surface area upon which the internal pressure of pressure vessel 102 acts to create the pressure induced piston force discussed above in reference to conventional material testing chamber assembly 50. As such, when material specimens are tested within in situ chamber assembly 100, the load signal from specimen deflection received by the load cell is independent of the pressure within pressure vessel 102. In addition, as movement of pull rod 104 relative to pressure vessel 102 does not change the volume occupied by pull rod 104 within pressure vessel 102, the available fluid volume within pressure vessel 102 does not change responsive to movement of pull rod 104 relative to pressure vessel 102. As such, movement of pull rod 104 relative to pressure vessel 102 occurs isochorically. In addition, when such movement occurs isothermally, the movement of pull rod 104 relative to pressure vessel 102 occurs isochorically and isobarically.

In the illustrated embodiment, fixed portion 120a of specimen retainer assembly 120 includes a plurality of threaded sockets that are used to couple fixed portion 120a of specimen retainer assembly 120 to one or more specimens. Likewise, movable portion 120b of specimen retainer assembly 120 includes a plurality of slots that are used to couple movable portion 120b of specimen retainer assembly 120 to the one or more specimens. In other embodiments, either or both of movable portion 120b and fixed portion 120a could have other features for coupling with the one or more specimens depending upon the type of material specimens being used and the type of testing being performed. In the illustrated embodiment, upper end cap 102c includes a plurality of pressure or fluid ports that are generally designated 124 that enable the pressurization of the fluid within pressure vessel 102. Likewise, lower end cap 102b includes a plurality of pressure or fluid ports that are generally designated 126 that enable the pressurization of the fluid within pressure vessel 102. A thermal jacket (not pictured), such as thermal jacket 46 discussed herein, may be positioned around pressure vessel 102 to heat or cool the fluid within pressure vessel 102.

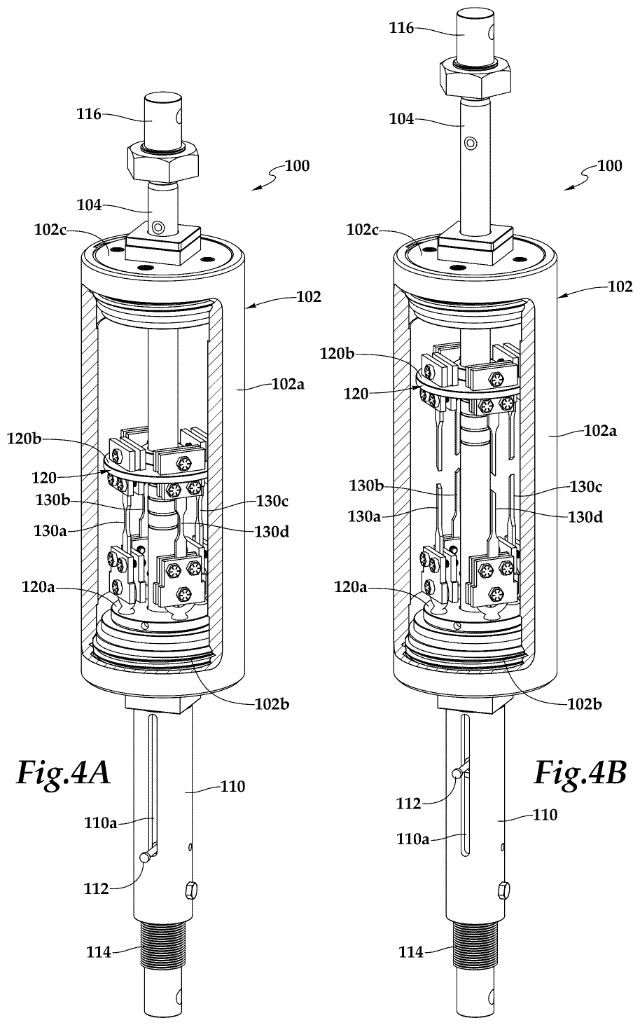

Referring additionally to FIGS. 4A-4B of the drawings, details relating to material testing will now be discussed. In FIG. 4A, four specimens have been loaded into in situ chamber assembly 100. Specifically, specimens 130a, 130b, 130c, 130d have been coupled to fixed portion 120a and movable portion 120b of specimen retainer assembly 120 using suitable grips. In the illustrated embodiment, specimens 130a, 130b, 130c, 130d are positioned radially outwardly relative to pull rod 104 and are uniformly circumferentially distributed about pull rod 104 at approximately ninety degree intervals with specimens 130a, 130c positioned on opposite sides of pull rod 104 and with specimens 130b, 130d positioned on opposite sides of pull rod 104. Even though four specimens have been depicted and described, it should be understood by those having ordinary skill in the art that other numbers of specimens both less than four and greater than four may be installed and tested within an in situ chamber assembly of the present disclosure. The actual number of specimens installed and tested within an in situ chamber assembly of the present disclosure will be determined based upon factors including the size of the pressure vessel relative to the size of the specimens, the type and duration of the testing procedure, the number of data points desired by the tester and other factors known to those having ordinary skill in the art.

The ability of in situ chamber assembly 100 to test multiple material specimens at the same time provides numerous benefits during material testing protocols. For example, prior to testing, it is common practice to age material specimens in a desired environment that may include any combination of pressure, temperature and fluid exposure as discussed herein for any desired duration of time. Any number of in situ chamber assemblies 100 may be loaded with a desired number of specimens that are exposed to a desired fluid media at a desired temperature and a desired pressure for a desired duration of time for in situ aging prior to in situ material testing. As in situ chamber assemblies 100 are self-contained and independent of the testing machine, the aging process only involves the required number of in situ chamber assemblies 100 and not an equal number of testing machines. Thus, the number of testing machines a laboratory requires need not be related to the number of in situ aging processes that are being performed as the testing machines are only needed during the in situ mechanical testing phase of the protocol.

In situ chamber assembly 100 is suitable for use in testing a wide variety of materials including, for example, soft materials such as foams and elastomers; rigid materials such as plastics, thermoplastics and thermosets; reinforced materials such as short fiber composites, pultruded composites and continuous fiber composites; hard materials such as metals and ceramics; strong material such as fibers from polymers, carbon, glass and metals; woven materials such as fabric, yarn, rope and webbing; metallic materials such as cables, mesh and sintered metal and other materials typically characterized by mechanical testing that involves material deformation including, for example, machined samples of composite pipe formed from two or more different materials such as multi-layer pipe, thermoplastic composite pipe, fiberglass-reinforced plastic pipe, cross-linked polyethylene pipe and high-density polyethylene pipe.

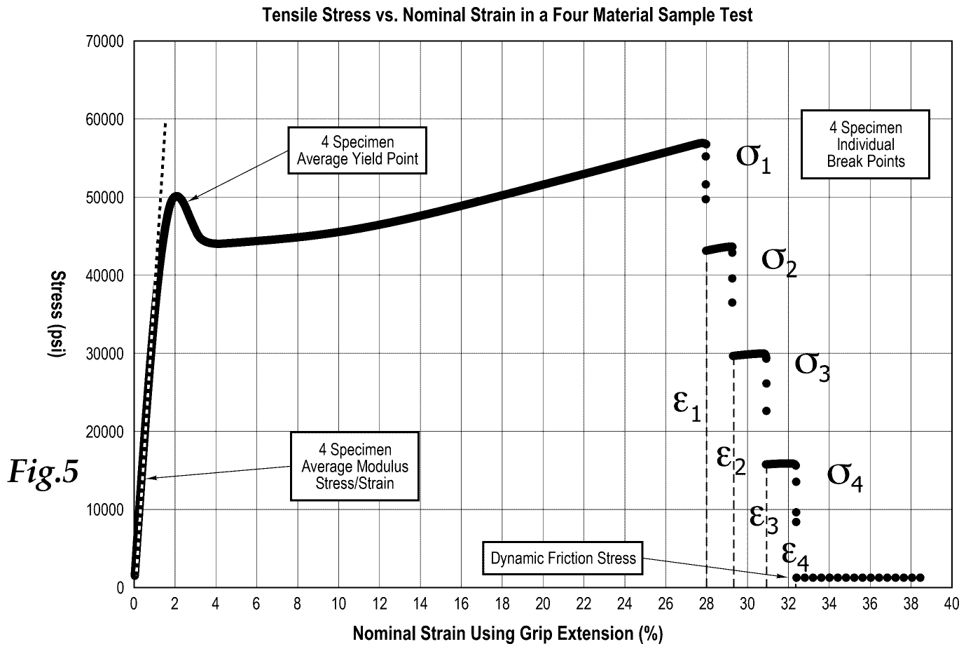

In FIG. 4A, four specimens 130a, 130b, 130c, 130d in the form of polymer dumbbells have been loaded into in situ chamber assembly 100 using suitable grips that are coupled to moveable portion 120b and fixed portion 120a of specimen retainer assembly 120. To perform a simultaneous tensile test including all four of specimens 130a, 130b, 130c, 130d, the crosshead of the universal testing machine is actuated to displace in an upward direction at a controlled rate. As the crosshead moves upwardly, pull rod 104 also moves upwardly relative to pressure vessel 102. As fixed portion 120a of specimen retainer assembly 120 is coupled to pressure vessel 102 and moveable portion 120b of specimen retainer assembly 120 is coupled to pull rod 104, the upward movement of pull rod 104 relative to pressure vessel 102 places a tensile load on specimens 130a, 130b, 130c, 130d which eventually causes each of specimens 130a, 130b, 130c, 130d to break, as best seen in FIG. 4B. In situ chamber assembly 100 not only provides a highly efficient mechanism for testing material specimens but also a highly effective mechanism for testing material specimens. For example, results of a tensile test performed using in situ chamber assembly 100 are presented in FIG. 5 of the drawings as a tensile stress versus nominal strain graph. The initial portion of the curve is a summation of specimens 130a, 130b, 130c, 130d until they start breaking. Note that stress is the load divided by the average initial cross section of specimens 130a, 130b, 130c, 130d. The nominal strain is calculated using crosshead displacement and/or initial grip separation. The modulus (stress/strain) and yield stress are divided by four to calculate an average value. The yield strain is measured and is the average value of specimens 130a, 130b, 130c, 130d. The stress at break is calculated as the difference in the break stresses using simple subtraction and is shown as 01, 02, 03, 04. The nominal strain at break for each specimen 130a, 130b, 130c, 130d is measured and shown as 81, 82, 83, 84. The friction load between pull rod 104 and dynamic seals 106, 108 is measured by continuing to move the crosshead after each of specimens 130a, 130b, 130c, 130d has broken. The friction load is subtracted from the load data to create an individual data set for each specimen 130a, 130b, 130c, 130d.

Alternatively or additionally, the friction load between pull rod 104 and dynamic seals 106, 108 may be measured prior to material testing when there is initially slack in the system. As another alternative, the friction load between pull rod 104 and dynamic seals 106, 108 may be measured after material testing by returning the crosshead to the start position of the material testing then rerunning the test without specimens to obtain friction measurements as pull rod 104 moves relative to dynamic seals 106, 108 such that friction data may be obtained at every location along the testing travel of pull rod 104 relative to dynamic seals 106, 108.

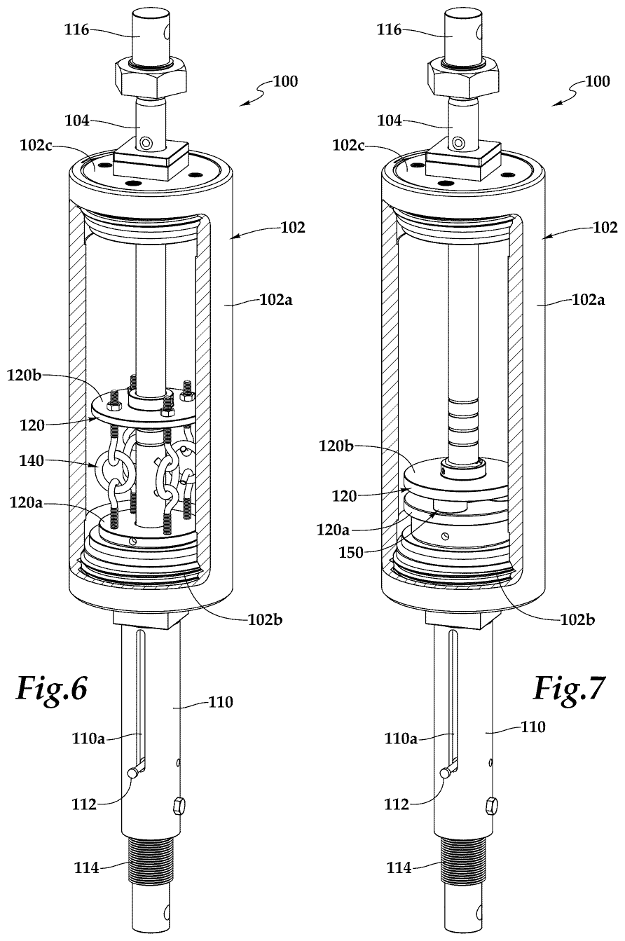

Even though material specimens in the form of dumbbells having been depicted in the tensile test of FIGS. 4A-4B, it should be understood by those having ordinary skill in the art that in situ chamber assembly 100 is equally well-suited for tensile testing material specimens that have other forms. For example, as best seen in FIG. 6, in situ chamber assembly 100 is being used to perform a tensile test on a plurality of specimens generally designated 140 in the form of material specimen rings which may be polymer rings such as elastomer O-rings. In other implementations, in situ chamber assembly 100 may being used to perform tensile tests on material specimens in the form of fibers, cables, cords, yarns, tapes, webbing, straps, films, sheets and slabs, to name a few.

Even though tensile testing has been depicted and described as an example of the testing performed using in situ chamber assembly 100, it should be understood by those having ordinary skill in the art that in situ chamber assembly 100 is equally well-suited for use in other types of mechanical testing. For example, as best seen in FIG. 7, in situ chamber assembly 100 is being used to perform a compression test on a plurality of specimens generally designated 150. In the illustrated embodiment, specimens 150 are in the form of elastomeric pucks. In other implementations, in situ chamber assembly 100 may be used to perform compression tests on specimens of other materials and/or in the forms such as tapes, rods, discs, buttons, cubes, prisms or other shapes. In addition, it should be noted that for compression tests, the specimens may not be coupled to both movable portion 120b and fixed portion 120a but rather positioned between movable portion 120b and fixed portion 120a for testing.

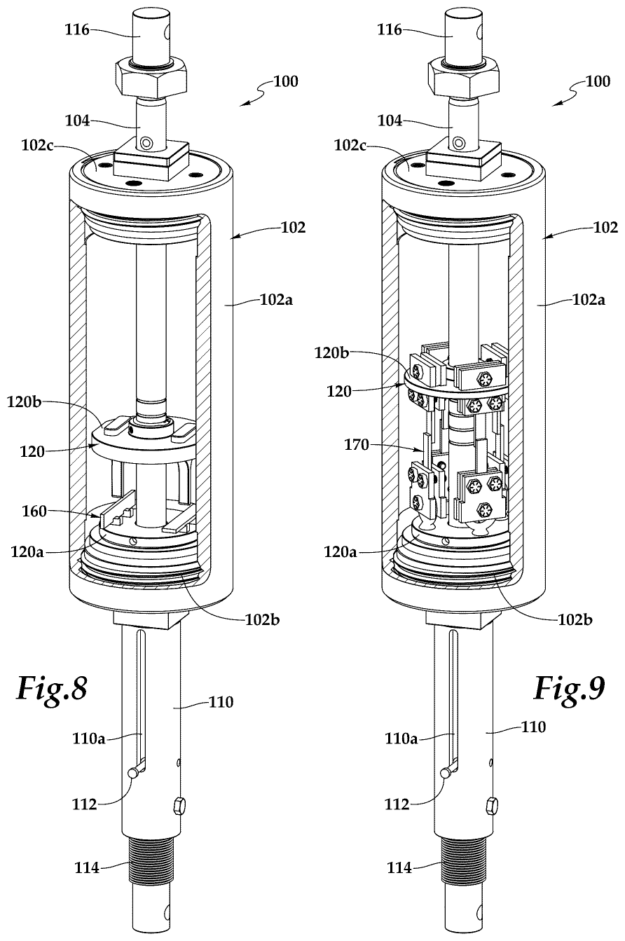

In another example, as best seen in FIG. 8, in situ chamber assembly 100 is being used to perform a bending test on a plurality of specimens generally designated 160. In the illustrated embodiment, specimens 160 are in the form of composite beams that are positioned on supports coupled to fixed portion 120a with bending tools coupled to movable portion 120b that are lowered into contact with specimens 160 to perform a three point bending mode test. Similarly, in situ chamber assembly 100 may be used for other types of bending tests such as cantilever tests and four point bending mode tests. In a further example, as best seen in FIG. 9, in situ chamber assembly 100 is being used to perform a shear test on a plurality of specimens generally designated 170. In the illustrated embodiment, specimens 170 are in the form of bonded specimens coupled between movable portion 120b and fixed portion 120a with suitable grips. In situ chamber assembly 100 is suitable for performing a variety of shear tests such as iosipescu tests, V-notched rail tests, hoop ring tensile tests and short beam shear tests, to name a few. In addition, it should be noted that bonded specimens may be mechanically tested using in situ chamber assembly 100 in a variety of ways including testing for tensile, peel, shear, compression and other properties.

Accordingly, those having ordinary skill in the art should understand that in situ chamber assembly 100 is a highly versatile tool that can be used for aging and testing an assortment of materials, in a diversity of forms, subjected to a range of environments and a variety of loads in isochoric conditions to obtain an abundance of material property data. For example, in addition to tensile, compression, bending and shear testing, in situ chamber assembly 100 is equally well-suited for use in other testing protocols such as testing slow crack growth of notched or unnotched specimens, dynamic testing of materials and long term testing of materials including slow crack growth testing, metal slow strain rate testing and stress corrosion cracking testing with such testing taking place over hours, days, weeks, months or even years. In addition, when in situ chamber assembly 100 is being used to age specimens that are coupled between movable portion 120b and fixed portion 120a that will be subject to material testing within in situ chamber assembly 100, additional free hanging specimens may also be aged within in situ chamber assembly 100. Following the mechanical testing of the test specimens and the return of in situ chamber assembly 100 to ambient conditions, the additional free hanging specimens may be removed from in situ chamber assembly 100 and tested at ambient conditions using, for example, a conventional material testing chamber assembly 50, as discussed with reference to FIGS. 2A-2B, such that traditional immersion change data can be compared with data measured using in situ chamber assembly 100 on comparably aged specimens.

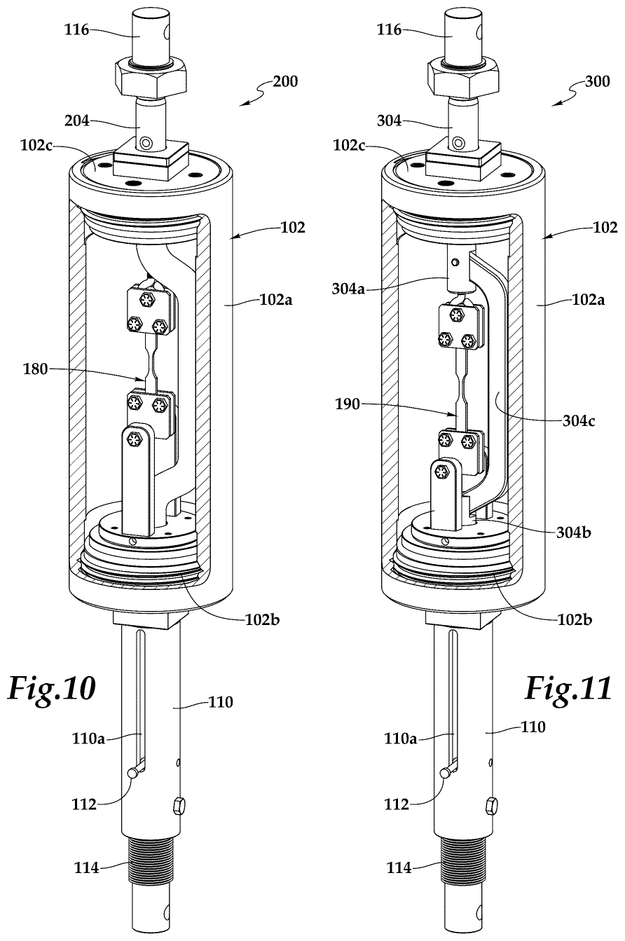

Even though a straight pull rod has been depicted and described for use with the in situ chamber assembly of the present disclosure to conduct isochoric, in situ mechanical testing of materials, it should be understood by those having ordinary skill in the art that other pull rod configurations capable of isochoric, in situ mechanical testing of materials are possible and are considered to be within the scope of the present disclosure. For example, as best seen in FIG. 10, in situ chamber assembly 200 has a bent pull rod 204 that extends through pressure vessel 102. Bent pull rod 204 includes a lower end that has a sliding and sealing relationship with lower end cap 102b and an upper end that has a sliding and sealing relationship with upper end cap 102c. Similar to pull rod 104 discussed herein, bent pull rod 204 maintains a constant volume and pressure condition within pressure vessel 102 during pull rod movement. It should be noted that, bent pull rod 204 has suitable stiffness such that the internal pressure acting on bent pull rod 204 does not impart a force onto the load cell. As such, the load signal from specimen deflection received by the load cell is independent of the pressure within pressure vessel 102 and movement of bent pull rod 204 relative to pressure vessel 102 occurs isochorically.

Even though a unitary pull rod has been depicted and described for use with the in situ chamber assembly of the present disclosure to conduct isochoric, in situ mechanical testing of materials, it should be understood by those having ordinary skill in the art that other pull rod configurations capable of isochoric, in situ mechanical testing of materials are possible and are considered to be within the scope of the present disclosure. For example, as best seen in FIG. 11, in situ chamber assembly 300 has a muti-part pull rod 304 that extends through pressure vessel 102. Muti-part pull rod 304 includes an upper end 304a that has a sliding and sealing relationship with upper end cap 102c, a lower end 304b that has a sliding and sealing relationship with lower end cap 102b and a central member 304c that couples upper end 304a and lower end 304b together. Similar to pull rod 104 discussed herein, muti-part pull rod 304 maintains a constant volume and pressure condition within pressure vessel 102 during pull rod movement. In the illustrated embodiment, the stiffness of central member 304c and its connections with upper end 304a and lower end 304b prevents any separation between upper end 304a and lower end 304b responsive to the internal pressure within pressure vessel 102 which could otherwise impart a force on the load cell. As such, the load signal from specimen deflection received by the load cell is independent of the pressure within pressure vessel 102 and movement of muti-part pull rod 304 relative to pressure vessel 102 occurs isochorically.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

1. An in situ chamber assembly for mechanical testing of materials, the in situ chamber assembly comprising:
a pressure vessel including first and second end caps;
a pull rod extending through the pressure vessel, the pull rod having a sliding and sealing relationship with the first and second end caps;
a specimen retainer assembly disposed within the pressure vessel, the specimen retainer assembly including a fixed portion coupled to the pressure vessel and a movable portion coupled to the pull rod; and
a plurality of specimens positioned between the fixed portion and the movable portion of the specimen retainer assembly, the specimens positioned radially outwardly relative to and uniformly circumferentially distributed about the pull rod;
wherein, movement of the pull rod relative to the pressure vessel is configured to apply a load on the specimens; and
wherein, movement of the pull rod relative to the pressure vessel occurs isochorically.

2. The in situ chamber assembly as recited in claim 1 further comprising a fluid sealed within the pressure vessel;
wherein, the specimens are exposed to the fluid.

3. The in situ chamber assembly as recited in claim 2 wherein, the fluid is in a gaseous state.

4. The in situ chamber assembly as recited in claim 2 wherein, the fluid is in a liquid state.

5. The in situ chamber assembly as recited in claim 2 wherein, the fluid is a multiphase fluid.

6. The in situ chamber assembly as recited in claim 2 wherein, the fluid has a temperature that is less than ambient temperature.

7. The in situ chamber assembly as recited in claim 2 wherein, the fluid has a temperature that is greater than ambient temperature.

8. The in situ chamber assembly as recited in claim 2 wherein, the fluid has a pressure that is less than ambient pressure.

9. The in situ chamber assembly as recited in claim 2 wherein, the fluid has a pressure that is greater than ambient pressure.

10. (canceled)

11. The in situ chamber assembly as recited in claim 1 wherein, the plurality of specimens includes first and second specimens positioned on opposite sides of the pull rod.

12. The in situ chamber assembly as recited in claim 1 wherein, the plurality of specimens includes first, second and third specimens positioned radially outwardly relative to and circumferentially distributed about the pull rod.

13. (canceled)

14. The in situ chamber assembly as recited in claim 1 further comprising a tubular coupled to the first end cap exterior of the pressure vessel;
wherein, the pull rod extends into the tubular; and
wherein, the tubular limits movement of the pull rod relative to the pressure vessel.

15. The in situ chamber assembly as recited in claim 1 wherein, the material of the specimens is selected from the group consisting of elastomers, polymers, thermoplastics, thermosets, foams, fibers, fabrics, composites, ceramics and metals.

16. The in situ chamber assembly as recited in claim 1 wherein, the load applied to the specimens responsive to movement of the pull rod relative to the pressure vessel is selected from the group consisting of tensile loads, compression loads, bending loads and shear loads.

17. The in situ chamber assembly as recited in claim 1 further comprising a thermal jacket positioned around an exterior of the pressure vessel.

18. An in situ chamber assembly for mechanical testing of materials, the in situ chamber assembly comprising:
a pressure vessel including first and second end caps;
a pull rod extending through the pressure vessel, the pull rod having a sliding and sealing relationship with the first and second end caps;
a specimen retainer assembly disposed within the pressure vessel, the specimen retainer assembly including a fixed portion coupled to the pressure vessel and a movable portion coupled to the pull rod;
a plurality of specimens positioned between the fixed portion and the movable portion of the specimen retainer assembly, the specimens positioned radially outwardly relative to and uniformly circumferentially distributed about the pull rod; and
a pressurized fluid sealed within the pressure vessel;
wherein, the specimens are exposed to the pressurized fluid;
wherein, movement of the pull rod relative to the pressure vessel is configured to apply a load on the specimens; and
wherein, movement of the pull rod relative to the pressure vessel occurs isochorically and isobarically.

19. A testing apparatus for mechanical testing of materials, the testing apparatus comprising:
a testing machine includes a loading frame having a base, a crosshead and a load cell coupled to the crosshead; and
an in situ chamber assembly coupled to the testing machine, the in situ chamber assembly comprising:
a pressure vessel including first and second end caps;
a pull rod extending through the pressure vessel, the pull rod having a sliding and sealing relationship with the first and second end caps, the pull rod having first and second ends with the first end of the pull rod coupled to the crosshead;
a specimen retainer assembly disposed within the pressure vessel, the specimen retainer assembly including a fixed portion coupled to the pressure vessel and a movable portion coupled to the pull rod;
a tubular having first and second ends, the first end of the tubular coupled to the first end cap and receiving the second end of the pull rod, the second end of the tubular coupled to the base of the loading frame; and
at least one specimen positioned between the fixed portion and the movable portion of the specimen retainer assembly;
wherein, movement of the pull rod relative to the pressure vessel is configured to apply a load on the at least one specimen;
wherein, the tubular limits movement of the pull rod relative to the pressure vessel;
wherein, load measurements taken by the load cell are independent of the pressure within the pressure vessel; and
wherein, movement of the pull rod relative to the pressure vessel occurs isochorically.

20. (canceled)
